(19) United States
(12) Patent Application Publication
(10) Pub. No.: US 2003/0105703 A1
(43) Pub. Date: Jun. 5, 2003

(54) Method and system for aiding investor decisions

(75) Inventors: Patrice Palsky, La Varenne (FR); Olivier Renault, London (GB); Olivier Scaillet, Geneva (CH)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: FRACTALES, Paris (FR)

(21) Appl. No.: 10/241,810

(22) Filed: Sep. 11, 2002

(30) Foreign Application Priority Data
Sep. 17, 2001 (FR) 0111998

(51) Int. Cl. G06F 17/60

(52) U.S. Cl. 705/36; 705/38

(57) ABSTRACT

In this method for aiding investor decisions, by estimating risks related to financial investments, at least one investment policy is formulated, financial scenarios are generated randomly from parameters making it possible to simulate all the probable movements in investment instruments, the randomly generated scenarios are applied to the investment policy, financial results corresponding to the application of the scenarios to the investment policy are calculated and the calculated financial results are displayed.

A variable representative of the results of a collection of quoted companies and a variable representative of the evaluation by a stock market of a multiple of the results of the companies are modelled independently.

The movements in the variable representative of the evaluation by the stock market is modelled by means of a stochastic process whose conditional probability density as a function of time converges to a stationary law.

The present invention relates to a method for aiding investor decisions, as well as to a corresponding system for aiding decisions.

More particularly, the present invention relates to a method and system for aiding investor decisions, such as those of institutional investors, allowing the a priori estimation of the risks related to financial investments.

Specifically, investors, and in particular institutional investors, are subject to medium- and long-term accounting and financial objectives.

It is therefore desirable to enable these investors to supply them with an estimation of the risk related to financial investments, in terms of accounting and financial risks.

Such an estimation is generally undertaken by randomly generating a very considerable number of financial scenarios, so as to make it possible to simulate all the probable movements in investment instruments. The financial results corresponding to the application of the scenarios to the envisaged investment policy are calculated thereafter. The financial results thus calculated are then displayed.

One of the widely adopted procedures for undertaking such an estimation of risks is known as the “Monte-Carlo” procedure.

This procedure is based essentially on the formulation of a probability law making it possible to model the movements in the performance of all the shares of a financial market or, in other words, to model the movements in a stock market index representative of the share price.

On the basis of this probability law, random draws are undertaken, in such a way as to obtain a corresponding number of probable values of the index or of the shares on the expiry of a predetermined investment period, and the financial results corresponding to each of the draws thus performed are calculated.

The formulation of the probability law is based mainly on the statistical finding according to which, over a period of twelve months, the performance rate of the shares of a financial market as a whole varies about a stable mean value, with a certain standard deviation. Hence, to formulate the probability law making it possible to model the performance of shares over twelve months, use is made, for example, of a normal law.

According to the “Monte-Carlo” procedure, the number of draws made is such as to make it possible to sample all the financial scenarios liable to occur. Thus, for example, a thousand draws may be made.

After calculation of the corresponding results for the investor, a relatively complete distribution of the probable results is obtained, this making it possible to evaluate and to chart the financial risks associated with a given financial policy.

However, the problem is more complex if, as is appreciated, rules of prudence compel continuous monitoring of the financial situation rather than annual examination.

For example, prudent rules may compel an investor to liquidate a position if the potential deficit of the holdings exceeds −10%. Hence, the financial results corresponding to the random draws no longer depend only on the performance of the holdings on completion of the investment period, but also on the variation in the value of the holdings in the course of time.

Consequently, the “Monte-Carlo” procedure must be generalized by undertaking a modelling of the variation in the price of the investment instruments as a function of time. The mathematical tools used to perform this modelling are known as “stochastic” processes.

A stochastic process is a series of random variables varying as a function of time.

The modelling of the variation in the share price as a function of time is based on the finding according to which, overall, the behaviours of financial indices are substantially regular and these behaviours may be regarded as stochastic processes whose parameters are fixed.

It is nevertheless appreciated that the efficiency of the model is intimately related to the type of stochastic process used.

As far as the “Monte-Carlo” procedure is concerned, a Gaussian type stochastic process is generally used. Thus, for example, a geometric Brownian model may be used. According to this process, the movements in a variable δW are given by the following relation: in which:

δW=μ·W·δt+σ·W·\sqrt{δt}·ω (1)

in which:

μ·δt represents a linear drift corresponding to the mean value of the increment of the process;

σ·\sqrt{δt·ω} represents the random portion of the increment of the process;

ω follows a normal law with mean 0 and standard deviation 1.

It is found that, according to this process, the mean of the value examined or, as far as the scenarios are concerned, the mean locus of the random paths, grows exponentially according to a continuous rate of growth. The standard deviation also grows exponentially according to a continuous rate of growth.

Hence, according to this technique, the process used to model the variation in the investment instruments as a function of time, and in particular in the shares, exhibits on average an exponential drift.

This procedure is therefore very sensitive to the choice of the parameter of mean rate of growth of prices.

The medium- or long-term assessment of the financial risks related to an investment in an investment instrument whose movements are modelled with the aid of a geometrical process exhibiting, on the one hand, a mean rate of growth of 7% and, on the other hand, a mean rate of growth of 5% would give, on a horizon of a few tens of years, a fundamentally different vision of the risk.

Moreover, according to this type of process, market occurrences arising in the course of the period of observation of the market are echoed fully in the long-term projections. Thus, for example, if an abrupt drop in the price of shares is observed over a short duration, all the long-term projections also decrease by an equivalent percentage. The long-term risk indicators are therefore fundamentally unstable with this procedure.

So, the aim of the invention is to alleviate this drawback and to provide a process for aiding investor decisions, making it possible to provide more relevant long-term projections.

Thus, according to the invention, there is proposed a method for aiding investor decisions, by estimating risks related to financial investments, comprising the formulation of at least one investment policy, the random generation of financial scenarios from parameters making it possible to simulate all the probable movements in investment instruments, the application of the randomly generated scenarios to the investment policy, the calculation of the financial results corresponding to the application of the scenarios to the investment policy and the displaying of the calculated financial results.

According to an essential aspect of this method, in the course of the random generation of the financial scenarios, a variable representative of the results of a collection of quoted companies and a variable representative of the evaluation by a stock market of a multiple of the results of the companies are modelled independently.

According to one mode of implementation of this method, the share price is reconstructed by modelling independently the rate of dividends associated with the shares, on the one hand, and the dividends, on the other hand and by calculating the share price from the dividend rate and from the dividends modelled.

According to another mode of implementation of this method, the share price is reconstructed by modelling independently the earnings and the price/earnings ratio (PER) of the companies.

According to a characteristic of this method, the movements in the said variable representative of the evaluation by the stock market is modelled by means of a random variable varying as a function of time and whose probability density converges to a stationary law.

For example, the variable is modelled by means of an “Ornstein-Uhlenbeck” type process.

According to another characteristic of this method, in the course of the displaying of the financial results, a graphical representation is undertaken of the movements as a function of time in the probability density of at least one economic variable related to the collection of scenarios generated and the results corresponding to the application of the scenarios to the investment policies are projected onto the said graphical representation.

According to another aspect of this method, the graphical representation of the scenarios is performed in a three-dimensional manner as a function of time, the value of a generated economic variable and the probability density associated therewith.

In response to a selecting of a specific value of an economic variable, it is also possible to make provision, in one mode of implementation of this method, for the displaying of the collection of corresponding scenarios culminating in the said value.

For example, in the course of the formulation of the or of each investment policy, a financial portfolio encompassing a collection of investment instruments is formulated and an investment strategy is formulated by allocating percentages of a sum invested to respective types of investment instrument.

In the course of the formulation of the or of each investment policy, a variable representative of a series of financial flows intended to be subsequently credited to or debited from the said portfolio is preferably input.

According to an advantageous mode of implementation, it is possible to study several financial portfolios in succession and to undertake the formulation of several financial strategies, the application of the randomly generated scenarios to the investment policy consisting in applying the generated scenarios to a selected portfolio and to a selected financial strategy.

The invention also proposes a computer program stored on a medium and intended to be loaded into the internal memory of a computer, comprising a collection of instruction codes adapted for the implementation of a decision aid method as defined hereinabove when it is executed within the computer.

According to the invention, there is finally proposed a system for aiding investor decisions, by estimating risks related to financial investments, comprising data storage means into which is loaded at least one financial portfolio encompassing a collection of investment instruments and data corresponding to an investment policy, means of generation of random financial scenarios on the basis of parameters making it possible to simulate all the probable movements in investment instruments, means of calculation for applying the randomly generated scenarios to the said investment policy and for the calculation of corresponding financial results, and a depiction device for displaying the movements in the calculated financial results.

According to one aspect of this system, the means of generation of the financial scenarios comprises means of modelling a first variable representative of the results of a collection of quoted companies and of a second variable representative of the evaluation by a stock market of a multiple of the results of the companies, independently of the modelling of the first variable.

According to another characteristic of this system, the means of generation of financial scenarios comprise means of generation of a random variable varying as a function of time and whose probability density converges to a stationary law.

For example, the random variable is modelled by means of an “Ornstein-Uhlenbeck” type process.

According to one embodiment, the system according to the invention furthermore comprises means for displaying the financial results calculated on three-dimensional surface representing a probability density associated with the randomly generated scenarios.

Other aims, characteristics and advantages of the invention will emerge from the following description, given merely by way of non-limiting example, and offered with reference to the appended drawings, in which:

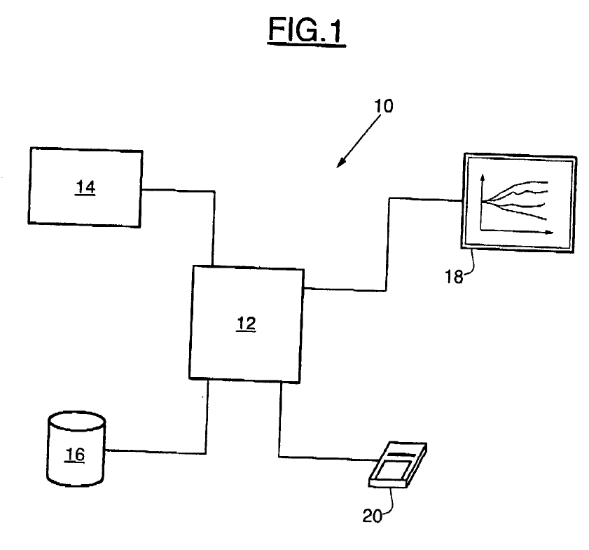

FIG. 1 is a schematic diagram showing the essential components of a system for aiding investor decisions in accordance with the invention;

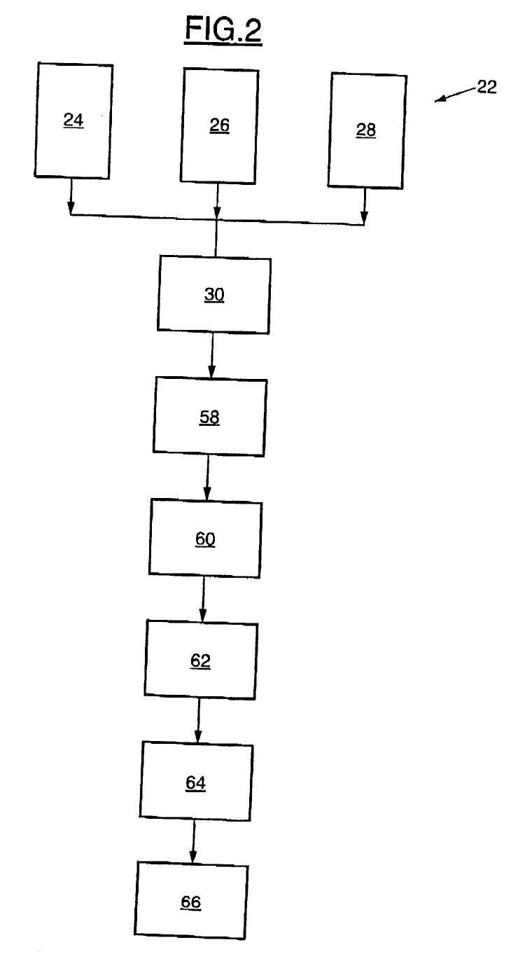

FIG. 2 is a flowchart showing the main phases of the decision aid method in accordance with the invention;

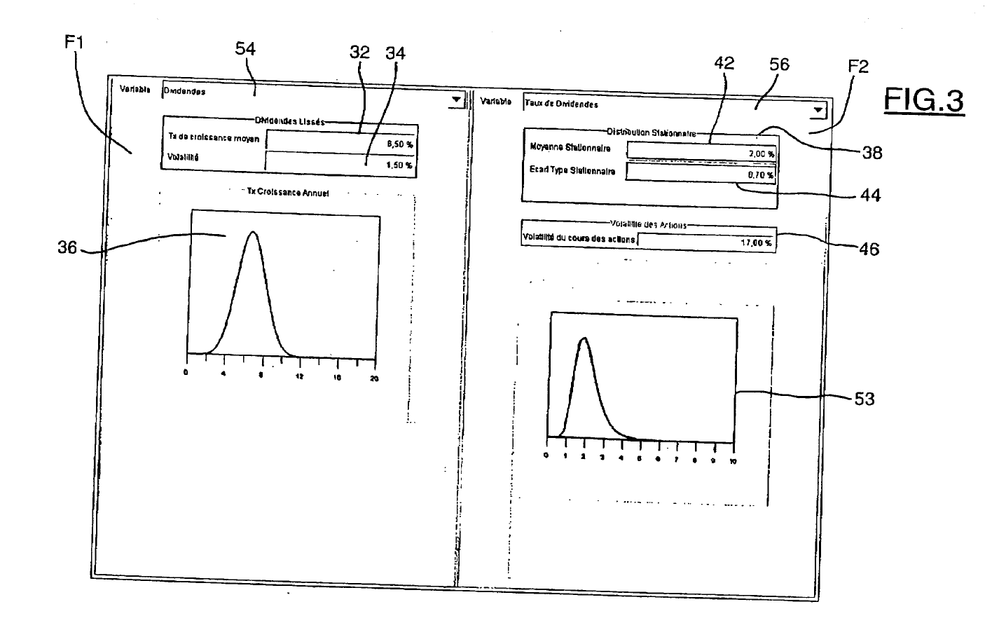

FIG. 3 is a screen print showing the inputting of the parameters used for the formulation of the randomly generated scenarios;

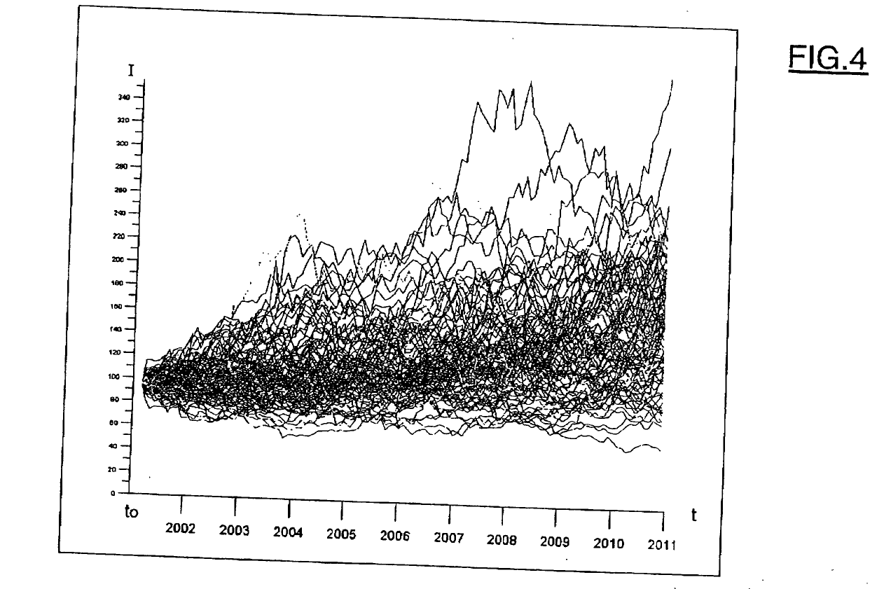

FIG. 4 is a screen print showing the collection of randomly generated scenarios;

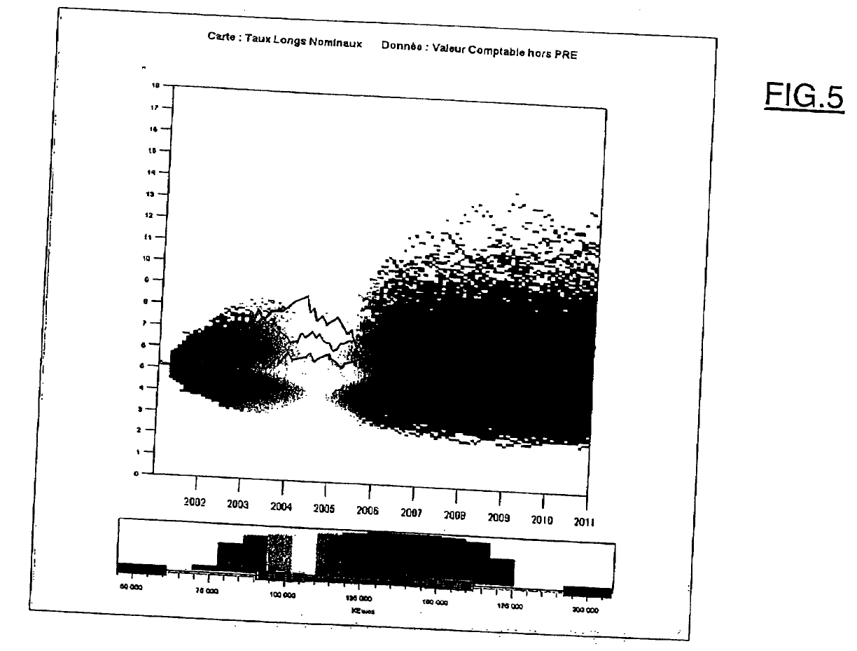

FIG. 5 illustrates a mode of presentation of the financial results emanating from the application of the scenarios to an investment policy; and

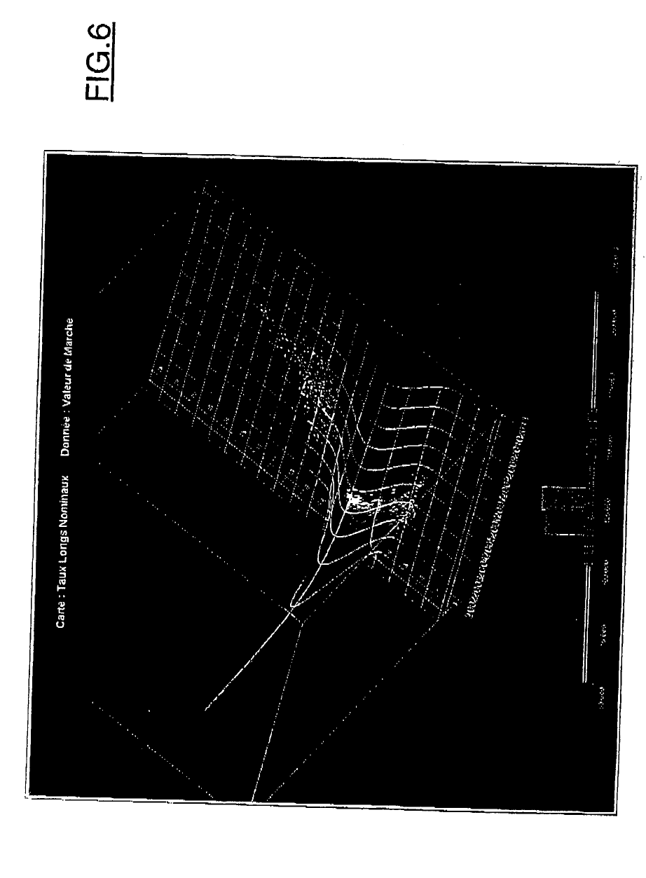

FIG. 6 illustrates another mode of presentation of the financial results, in three dimensions.

Represented in FIG. 1 is a system for aiding investor decisions, designated by the general numerical reference 10.

It is intended for presenting an investor with an estimate of the financial risks related to investments which he envisages making. More particularly, this system is intended for presenting the investor with all the probable incidences, in accounting and financial terms, of an envisaged investment policy, and to formulate a chart of the financial and accounting risks incurred.

As may be seen in FIG. 1, this system 10 essentially comprises a central unit 12 hooked up to a man/machine interface 14 enabling the user to enter parameters allowing, as will be described in detail subsequently, the random generation of financial scenarios, and to storage means 16 into which are loaded, in particular, files in which one or more investment portfolios are incorporated.

Furthermore, the system 10 comprises peripheral systems, consisting of a display device 18 as well as of a printer 20, making it possible to present the investor with all the financial results corresponding to the scenarios generated within the central unit 12, in a form making it possible to identify the risks incurred.

As indicated previously, this system 10 is intended to provide an investor with on the one hand an estimate of the gains which he may expect following an investment executed in investment instruments corresponding to a predetermined investment policy, as well as, on the other hand, an estimate of the risks according to which these gains may be anticipated.

This system is adapted for providing an investor with a chart of the surpluses or of the deficits which may be realised on completion of a predetermined time period, for example ten years.

The system 10 is furthermore adapted to indicate, to the investor, the movements in the potential gains and in the risks incurred, as a function of time, doing so with a predetermined stepsize, for example one month.

To do this, the central unit 12 incorporates all the software means making it possible to carry out a random generation of financial scenarios from parameters making it possible to simulate all the probable movements in investment instruments, so as to apply the randomly generated scenarios to a predetermined investment policy, and so as to calculate the financial results corresponding to the application of these scenarios to the investment policy.

Referring to FIG. 2, the first phase 22 of the decision aid method implemented within the central unit 12 consists in the formulation of one or more investment policies.

To do this, it is expedient to undertake the formulation of one or more investment portfolios, in the form of files of lines of holdings, for example shares, stored in memory in the storage means 16 (step 24).

It is also possible to build in a “cash-flow” assumption, that is to say an assumption regarding series of financial flows intended subsequently to be credited to or debited from one of the portfolios formulated during the previous step 24 (step 26).

An investment strategy is then formulated, by determining the allocations of shares, in terms of types of holdings in which it is expedient to invest (step 28).

During the next step 30, it is expedient to undertake the inputting of parameters of the stochastic processes used to model the movements in the economic variables.

Represented in FIG. 3 is a screen print obtained by means of the display device 18 allowing an investor, jointly with the interface 14, to enter all these parameters into the central unit 12 and to display them.

As may be seen in this figure, this display screen allows the investor, after selecting an economic variable, to input the parameters defining the movements in this variable.

For this purpose, the central unit 12 causes the displaying of input windows each allowing input of the parameters corresponding to a variable.

For example, and as represented in this FIG. 3, in the course of this step 30, as far as the investment instruments consisting of shares are concerned, two windows F1 and F2 can be used to input the parameters allowing a modelling of the movements in the dividends and in the dividend rate associated therewith.

It is known in this regard that the price of a share can be modelled on the basis of these two elements.

Thus, in this case, as far as the dividends (window F1) are concerned, it is expedient to enter the mean rate of growth, fixed in this instance at 6.50%, as well as the volatility, set to a level of 1.50% (fields 32 and 34).

In response, the computer causes the depiction, on the display device 18, of a window 36 making it possible to display the probability density of the annual rate of growth of the dividends.

Likewise, the second window F2 can be used to input the parameters allowing a simulation of the movements in the dividend rate, in terms of stationary distribution (field 38).

In this first field 38 allowing the entry of the parameters corresponding to the stationary distribution, the input screen allows the entry of the stationary mean, fixed for example at 2% (field 42), of the dividend rate, the stationary standard deviation level, fixed for example at 0.70% (field 44), as well as the volatility of the shares (field 46), fixed for example at 17%.

After inputting of these parameters, the central unit 12 causes the depiction, on the second window of the input screen, of a window 53 making it possible to display the stationary distribution of the dividend rate, as well as optionally the conditional distribution of the dividend rate.

As is appreciated, in the course of this step 30 of the method, all the types of stochastic processes used can be configured by the investor. Thus, for example, parameters corresponding to long rates, to short rates, to inflation, or to share price, may be entered by the investor, by selecting respective input zones formed in response to a choice made by means of appropriate selection windows 54 and 56 taking the form for example of a drop-down menu.

It will be noted that, as indicated previously, as far as the movements in the share price are concerned, these movements may be expressed on the basis of the movements in the dividends and the movements in the dividend rate.

It is thus possible to undertake a modelling of the share price on the basis of these two elements, dividend on the one hand, and dividend rate on the other hand, the price being expressible as the quotient of the dividends and the dividend rate.

Thus, to undertake a modelling of the movements in the share price as a function of time, the central unit 12 undertakes separate modellings of the dividends and of the dividend rate of the shares, this corresponding in fact to a separate modelling of the dividends and of the share prices.

Owing to the stochastic process used for its modelling, the dividend rate oscillates about a long-term fixed mean. It follows from this that the mean rate of growth of the prices is identical to that of the long-term dividends, this corresponding to a finding made with regard to the past movements of the two rates of growth.

However, the modelling process used makes it possible to specify a transient stage during which the prices move on average more slowly or more quickly than the dividends, so as to catch up with a long-term stationary mean dividend rate, which would not be made possible by a modelling of prices by a modelling process of geometrical Brownian type.

To undertake a modelling of the dividends and of the rate of the dividends associated with the shares, the central unit 12 uses a stochastic process whose conditional probability density (that is to say varying as a function of time) converges to a stationary law, so as to avoid obtaining, over the very long term, rogue results.

For example, to undertake the modelling of the dividend rate, an “Ornstein-Uhlenbeck” type process is used.

Such a process consists of a mathematical process of conventional type within the scope of the person skilled in the art. It will not therefore be described in detail hereinbelow. It will however be noted that, while over the short term it resembles a Brownian process, over the long term it exhibits a fundamental difference insofar as it ensures a return to the long-term stationary mean.

According to such an arithmetic process, the movements δO in a variable between t and t+δt satisfy the following relation:

δO=K·(Θ−Ot)·δt+σ·\sqrt{δt}·ω (2)

in which:

K represents the elasticity or the restoring force of the process;

1 represents the long-term mean; and

Ot designates the initial value of 0.

It is noted that for a positive value of K, if Ot is less than 1, the drift is positive.

The drift is negative if Ot is greater than 1. This property of the drift ensures that the variable returns to the mean over the long term.

After having undertaken an input of the parameters of all the variables liable to have an influence on the movements in the investment instruments corresponding to an investment policy, during the next step 58, the central unit 12 undertakes a random generation of a predetermined number of financial scenarios, which number is sufficient to reflect all the probable movements in the investment instruments. For example, 1000 random draws are undertaken.

For this purpose, the central unit uses the stochastic processes previously mentioned, which make it possible to model the movements in the economic variables as a function of time and undertakes random draws, with a predetermined stepsize, for example one month. It is thus possible to simulate all the probable movements in a selected variable, such as dividend, dividend rate, long rates, short rates, inflation, share prices, etc. making it possible to have an influence on an investment instrument corresponding to an investment policy.

Represented in FIG. 4 is a screen print of the display device 18 showing 100 scenarios each corresponding to a probable movement in an index I representative of the price of shares of a financial market, as a function of time, from an instant T0 corresponding to an index of origin I=100.

As will be indicated hereinbelow, it is also possible, as a variant, to provide a representation of the scenarios in a three-dimensional reference frame, so as to associate with the movements in the level of the shares as a function of time, an indication of the corresponding probability density.

During the next step 60, the central unit 12 carries out a matching between, on the one hand, an investment policy selected by an investor, corresponding to an associated predetermined portfolio and to an associated share allocation strategy, as the case may be, to a cash-flow assumption and, on the other hand, the collection of scenarios generated in the course of the previous step 58, then undertakes a calculation of the corresponding accounting and financial results (step 62).

An estimation is thus available of all the probable movements in the results, in terms of gain or loss, related to an investment policy.

The scheme making it possible to calculate the financial and accounting results on the basis in particular of movements in the share price or, generally in investment instruments or in an index reflecting their movements, in an investment portfolio, in a share allocation strategy and, as the case may be, in a cash-flow, is a scheme within the scope of the person skilled in the art. It will not therefore be described in detail hereinbelow, insofar as it consists essentially in calculating, for each stepsize of the arithmetic process, the value of the portfolio, on the basis of the movements in one of the parameters representative of the movements in the corresponding investment instrument obtained by random drawing and the consequent value of the financial result for the investor.

During the next step 64, the central unit 12 undertakes a displaying of the financial results thus calculated, by projection of the results onto three-dimensional surfaces whose dimensions consist of time, the value of a generated economic variable and the probability density associated therewith, and identification of zones corresponding to financial risks greater than allowable thresholds.

As indicated previously, such a representation can be performed according to a two-dimensional representation, as may be seen in FIG. 5, in which a projection of the financial results corresponding to the application of randomly generated scenarios to a predefined investment policy has been represented. In this figure, the scenarios are represented by the movements in the nominal long rates as a function of time.

Of course, the financial results may also be projected onto three-dimensional surfaces formulated on the basis of the movements in any other available economic variable, such as nominal short rates, inflation, etc.

As may be seen in FIG. 5, preferably, the central unit 12 furthermore causes the joint depiction of a histogram on the display window making it possible to present the investor with information pertaining to the probable value of a portfolio corresponding to the investment strategy throughout the duration of simulation.

Moreover, it is possible to make provision for a selecting of the display modes in such a way as to allow a displaying of the results projected onto the aforesaid surface, either in the form of accounting data, or in the form of financial data.

It is also possible, as a variant, and as may be seen in FIG. 6, to supplement this display with a third dimension, representing the corresponding probability densities.

Referring finally to FIG. 2 and to FIG. 5, it may be seen that, in the course of this display step, it is possible to undertake the selection of a point P on a three-dimensional surface thus displayed (step 64).

In response, the central unit 12 undertakes the displaying of all the scenarios passing or culminating at this point P (step 66).

It will be noted finally that the invention is not limited to the mode of implementation described previously.

Specifically, while according to the method described hereinabove, the share price is calculated on the basis of an independent modelling of the rate of dividends associated with the shares, on the one hand, and of the dividends, on the other hand and by calculating the ratio of the dividends to the rate of the dividends, it is also possible, as a variant, to calculate the share price on the basis of a modelling of the earnings, on the one hand, and of the price/earnings ratio or PER, the price of the shares then being expressible in the form of the product of the earnings times the price earnings ratio.

In other words, generally, the share price can be calculated on the basis of a modelling of a variable representative of the results of a collection of quoted companies and of a variable representative of the evaluation by a stock market of a multiple of the results of the companies.

1. Method for aiding investor decisions, by estimating risks related to financial investments, comprising the formulation of at least one investment policy, the random generation of financial scenarios making it possible to simulate all the probable movements in investment instruments, the application of the randomly generated scenarios to the investment policy, the calculation of the financial results corresponding to the application of the scenarios to the investment policy and the displaying of the calculated financial results, characterized in that, in the course of the random generation of the financial scenarios, a variable representative of the results of a collection of quoted companies and a variable representative of the evaluation by a stock market of a multiple of the results of the companies are modelled independently.

2. Method according to claim 1, characterized in that the share price is reconstructed by modelling independently the rate of dividends associated with the shares, on the one hand, and the dividends, on the other hand and by calculating the share price from the dividend rate and from the dividends modelled.

3. Method according to claim 1, characterized in that the share price is reconstructed by modelling independently the earnings and the price/earnings ratio (PER) of the companies.

4. Method according to any one of claims 1 to 3, characterized in that the movements in the said variable representative of the evaluation by the stock market is modelled by means of a random variable varying as a function of time and whose probability density converges to a stationary law.

5. Method according to claim 4, characterized in that the variable is modelled by means of an “Ornstein-Uhlenbeck” type process.

6. Method according to any one of claims 1 to 5, characterized in that in the course of the displaying of the financial results, a graphical representation is undertaken of the movements as a function of time in the probability density of at least one economic variable related to the collection of scenarios generated and the results corresponding to the application of the scenarios to the investment policies are projected onto the said graphical representation.

7. Method according to claim 6, characterized in that the graphical representation of the scenarios is performed in a three-dimensional manner as a function of time, the value of a generated economic variable and the probability density associated therewith.

8. Method according to one of claims 6 and 7, characterized in that, in response to a selecting of a specific value of an economic variable, the displaying of the collection of corresponding scenarios culminating in the said value is undertaken.

9. Method according to any one of claims 1 to 8, characterized in that in the course of the formulation of the or of each investment policy, a financial portfolio encompassing a collection of investment instruments is formulated and an investment strategy is formulated by allocating percentages of a sum invested to respective types of investment instrument.

10. Method according to claim 9, characterized in that in the course of the formulation of the or of each investment policy, a variable representative of a series of financial flows intended to be subsequently credited to or debited from the said portfolio is input.

11. Method according to one of claims 9 and 10, characterized in that the formulation of several financial portfolios and of several financial strategies is undertaken, the application of the randomly generated scenarios to the investment policy consisting in applying the generated scenarios to a selected portfolio and to a selected financial strategy.

12. Computer program stored on a medium and intended to be loaded into the internal memory of a computer, characterized in that it comprises a collection of instruction codes adapted for the implementation of a decision aid method according to any one of claims 1 to 11, when it is executed within the computer.

13. System for aiding investor decisions, by estimating risks related to financial investments, comprising data storage means into which is loaded at least one financial portfolio encompassing a collection of investment instruments and data corresponding to an investment policy, means (12) of generation of random financial scenarios on the basis of parameters making it possible to simulate all the probable movements in investment instruments, means (12) of calculation for applying the randomly generated scenarios to the said investment policy and for the calculation of corresponding financial results, and a depiction device (18) for displaying the movements in the calculated financial results, characterized in that the means of generation of the financial scenarios comprises means of modelling a first variable representative of the results of a collection of quoted companies and of a second variable representative of the evaluation by a stock market of a multiple of the results of the companies, independently of the modelling of the first variable.

14. Decision aid system according to claim 13, characterized in that the means of generation of financial scenarios comprise means of generation of a random variable varying as a function of time and whose probability density converges to a stationary law.

15. System according to claim 14, characterized in that the random variable is modelled by means of an “Ornstein-Uhlenbeck” type process.

16. Decision aid system according to any one of claims 13 to 15, characterized in that it furthermore comprises means for displaying the financial results calculated on three-dimensional surface representing a probability density associated with the randomly generated scenarios.
